(19) United States
(12) Patent Application Publication
(10) Pub. No.: US 2002/0080230 A1
(43) Pub. Date: Jun. 27, 2002

(54) INCLUDING A PERSONS IMAGE IN A STORE

(75) Inventors: RICHARD VAN DE SLUIS, EINDHOVEN (NL); HANDOKO KOHAR, EINDHOVEN (NL); JOHANNES JANSEN, EINDHOVEN (NL)

Correspondence Address: CORPORATE PATENT COUNSEL, US PHILIPS CORPORATION, 580 WHITE PLAINS ROAD, TARRYTOWN, NY, 10591

(73) Assignee: U.S PHILIPS CORPORATION

(21) Appl. No.: 09/401,929

(22) Filed: Sep. 23, 1999

(30) Foreign Application Priority Data
Sep. 23, 1998 (EP) 98203184.1

(51) Int. Cl. H04N 7/14

(52) U.S. Cl. 348/14.01

(57) ABSTRACT

The invention relates to stores of information on a plurality of persons, such as a directory of subscribers to a communication network. In order to be able to browse through and select a particular person from such a store on the basis of image data, there is a need for a way of including image data into the store that is fast and easy. In accordance with the method of the invention, this is achieved by: establishing a video connection with a person whose image data is to be included; receiving a sequence of video frames making up the video connection; selecting a particular video frame from the sequence of video frames; and storing at least part of that particular video frame in the store.

The invention relates to a method of and an apparatus for providing an electronically accessible store of information comprising a plurality of entries of a plurality of corresponding persons with an image of one of these persons.

U.S. Pat. No. 5,533,110 discloses a method of providing a visual indication to a first communication connection subscriber of the status of a communication connection. The method is comprised of providing an icon on a display that represents the first subscriber, providing a call setup icon on the display representing a command to set up a, dragging the icon representing the first subscriber to the call setup icon, automatically displaying a directory of subscribers, dragging an identity of a second subscriber from the directory to the call setup icon and establishing a communication connection between communication apparatus used by the first subscriber and communication apparatus used by the second subscriber via subscriber's lines. In the step of automatically displaying the directory of subscribers, the directory can be formed of alphanumeric characters, designating the names of persons listed in the directory, or the names and telephone numbers, or images of the faces of the persons listed in the directory, or combinations of the above.

According to the known method, drawn or scanned images of the faces could be shown. Both kinds of images constitute a rather awkward way to add image data of persons to the store.

It is an object of the invention to provide a method as specified in the preamble, which is faster and easier than the method described above. To this end, a method according to the invention is characterized in that it comprises the steps of:

establishing a video connection with the person in question via a communication network;

receiving a sequence of video frames making up the video connection;

selecting a particular video frame from the sequence of video frames; and

storing at least part of that particular video frame as the image in the store.

The video connection connects at least two parties and one of the parties receives said sequence of video frames. In general, the other party or parties will receive a similar sequence or sequences so that the video connection is symmetrical. The video connection can be established between the parties for the sole purpose of obtaining the image data to be included in the store, or, alternatively, the video connection can already be in progress for some other reason when one of the parties to the video connection decides to include an other party's image in the store, e.g. in a local subscriber directory. In either case, obtaining the image data of the person in question by way of the invention is fast and easy, and there is no need for generating and sending separate image data.

The selection of a frame and the subsequent processing for the storage of image data in the store, could be automated and invoked, for example, by a party of the video connection pushing a button. Alternatively, after terminating the video connection, when it is established that a party has been connected to another party for the first time, he can be presented with an automatically generated pre-selection of at least one frame, from which he can select the image data to be stored in the directory. It is noted that the term ‘sequence of frames’ in this text should not be interpreted in a narrow sense. It is meant to indicate any collection of data from which a temporal sequence of images can be derived. When use is made of video compression, for example, not only independent frames are transmitted but also intermediate entities representing differences with respect to previous and/or subsequent images. In this sense, the term ‘frame’ means any snapshot from this collection of data.

Preferably but not exclusively, the method of the invention is used in combination with the step of enabling selection of an entry from the store on the basis of the thus obtained images. For example, this enabling step comprises the steps of presenting the available images on a display, providing an indicium on the display, the indicium indicating which one of the entries is ready for selection in response to an input signal; and moving the indicium on the display in response to a further input signal. With a touch pad, the indicium can be left out, as a user can directly point out the wanted person with his finger. Alternative ways of selecting among a number of images are possible. For example, the images can be presented on top of one another, whereas by turning a knob or moving a (virtual) slider the display switches from one image to the next one. This method has the advantage that little display space is needed, which makes it particularly suited for portable applications. The image data can also be presented to the user after he has made his selection. If, for example, the user is able to select on the basis of speech, i.e. the selection is made by verbally expressing the name of the wanted person, the corresponding image data can be presented to the user as a kind of check.

The invention is particularly advantageous in a communication environment, like the one described above. In such an environment, the plurality of persons are subscribers to a communication network and the store has a function as directory of these subscribers. When displayed, the directory shows identities of the subscribers, each one of these identities comprising image data of a corresponding one of the subscribers. Then, preferably, the selection of an identity of a subscriber invokes establishing a communication connection with that subscriber. The invention, however, is applicable in any other environment which comprises on the one hand an electronically accessible store of information on a plurality of persons and on the other hand means for establishing a video connection. An example of such an other environment is a personnel department keeping a store of information about the employees. A further example is a PDA (personal digital assistant) with a store comprising a collection of electronic business cards. Basically, the difference between the communication environment and the latter two environments is that in the latter the emphasis is not on (establishing) communication connections, but on other information and/or functions.

The invention further relates to a communication apparatus enabled for executing a method in accordance with the invention.

These and other aspects of the invention will be apparent from and elucidated with reference to the embodiments described hereinafter.

In the drawings:

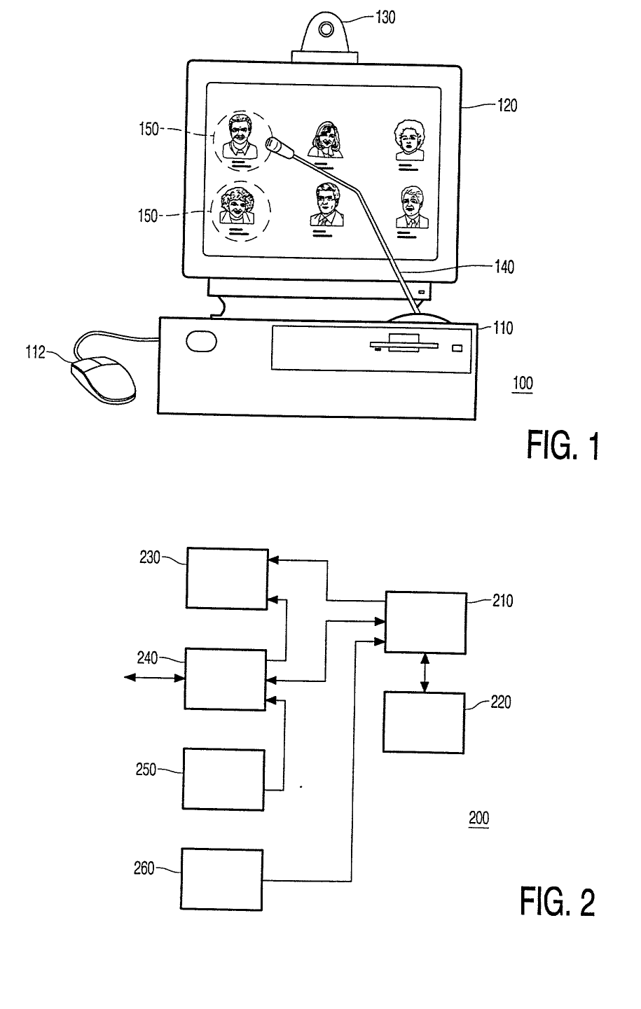

FIG. 1 shows an example of a communication apparatus in which an embodiment of the invention may be readily employed;

FIG. 2 shows a block diagram of a communication apparatus in accordance with the invention; and

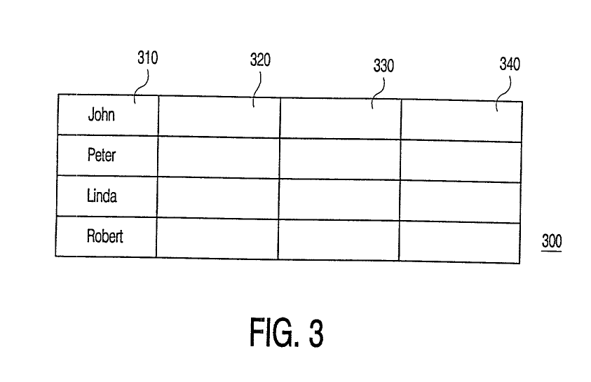

FIG. 3 shows a diagram of a directory as used in the communication apparatus of FIG. 2.

FIG. 1 shows an example of a communication apparatus 100 in which an embodiment of the invention may be readily employed. It comprises a computer 110, e.g. a PC, running videophone software, a pointing device 112, a display 120, a camera 130 and a microphone 140. The communication apparatus 100 is connected to a communication network, which is an ordinary telephone network in this embodiment, but which could be any network allowing a video connection between individual subscribers to the network. In the context of this text, it is to be understood that the term ‘subscriber’ is used to indicate any person using the network.

The videophone software maintains a subscriber directory that is stored in a non-volatile memory of the computer 10. Each entry in the subscriber directory belongs to a person who is accessible via videophone, generally a subscriber to the network. The subscriber directory contains for each entry a number of fields, such as the subscriber's name, address, phone number, image, or any combination of such fields. The subscriber directory can be presented on the display 120, prior to the person establishing a videophone connection. Hereto, one or more entries are represented by one or more corresponding identities 150, as shown in FIG. 1. Each one of the identities 150 comprises at least an image of the corresponding person and preferably his or her name. The communication apparatus 100 enables selection of a person to be called from the subscriber directory by pointing with the pointing device 112 to the identity representing that person. By showing the images of the persons contained in the directory, an easy way is provided for selecting a party to be called, which also works in case the name of that party has been forgotten.

The directory could be made available to further communication apparatus as well, either by these devices accessing the communication apparatus 100 or by downloading the directory to these other devices. This is particularly handy when the subscriber uses besides the communication apparatus 100 a number of further communication apparatus, such as a stand-alone telephone set, a mobile phone, etc. In this way, the subscriber has to keep only one directory. The directory could alternatively be stored centrally somewhere in the network, with, for example, subscribers renting some memory from a provider for keeping their personal directories. This approach provides access to the directory independent of the particular communication apparatus a subscriber happens to be using.

FIG. 2 shows a block diagram of a communication apparatus 200 in accordance with the invention. The communication apparatus 200 comprises a microprocessing unit 210 for running system software and application software such as videophone and videoconference software, and a memory 220 for storing the subscriber directory and the system and application software. The memory 220 is at least in part non-volatile for storing the subscriber directory during power down of the communication apparatus 200. The communication apparatus 200 further comprises a display 230, a connection unit 240, a camera 250 and a pointing device 260. The connection unit 240 takes care of establishing a video connection and subsequently receiving a sequence of video frames during the video connection. In the embodiment of FIG. 2, the connection unit 240 comprises a tangible telephone modem in combination with software running on the microprocessing unit 210. In dedicated communication apparatus such as videophones and videoconference terminals, the connection unit could be less tangible and would normally be more densely integrated with other parts of the communication apparatus.

The principal purpose of the display 230 during a video connection is displaying the received video frames. The display 230 further functions as (part of) a user interface, in combination with the pointing device 260 which is used for generating input signals. On the display 230, a subscriber directory can be invoked to be presented. The directory comprises a plurality of entries of a plurality of corresponding persons or subscribers. The microprocessing unit 210 is the means for controlling the directory, i.e. updating and maintaining the directory and presenting the directory to the user. The presentation of the directory consists of the presentation of identities of the entries on the display. At least a number of such identities comprise image data of the corresponding persons. Hereto, in accordance with the invention, the microprocessing unit 210 enables selection of a particular video frame from the sequence of video frames that are received during a video connection and subsequently stores at least part of that particular video frame in the directory.

In the present embodiment of the invention, selection of an identity of a person leads to that person being called in order to establish a video connection. Hereto, the microprocessing unit 210 will activate the connection unit 240 in response to the selection of an identity. Alternatively, selection of an identity of a person could lead to an overview of communication channels to be presented that can be used for contacting the selected person, e.g. ordinary telephone, videophone, e-mail, voice-mail, video-mail, etc. Only then will the user make his choice which of the communication channels to use. Numerous other implementations are possible.

In the embodiments of FIG. 1 and FIG. 2, the subscriber directory is stored locally in the communication apparatus. Alternatively, the subscriber directory can be stored centrally on a server somewhere in the network. In a further alternative embodiment of the invention, the communication apparatus could be a small handheld unit, like a personal digital assistant or a cellular phone, in which all required hardware and software is integrated.

FIG. 3 shows a diagram of a directory 300 as used in the communication apparatus of FIG. 2. The directory 300 is organized as a matrix, with each row comprising a number of fields belonging to a single person or entry. A first field 310 comprises the name of that person. In second and third fields 320, 330 further information is stored, such as the telephone number to be used for establishing a videophone connection with that person, his home address, etc. The image data obtained by means of the invention are stored in a subsequent field 340. In an alternative embodiment of the invention, the field 340 can be supplied with image data either obtained by means of the invention or from an alternative source, depending on one's preferences. Image data from alternative sources could comprise, for example, image data that is generated by the owner of the directory and image data that is separately sent along with the video data during the video connection.

It is clear that the directory could contain further information instead of, or in addition to the information shown in FIG. 3 and that the directory could be organized in many other ways without departing from the invention. The fields 310, 320, 330 and 340 could, for example, contain only pointers to memory locations where the actual information is stored.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. The invention can be implemented by means of hardware comprising several distinct elements, and by means of a suitably programmed computer. In the device claims enumerating several means, several of these means can be embodied by one and the same item of hardware.

1. Method of providing an electronically accessible store of information comprising a plurality of entries of a plurality of corresponding persons with an image of one of said persons, characterized in that the method comprises the steps of:
establishing a video connection with said one of said persons via a communication network;
receiving a sequence of video frames making up the video connection;
selecting a particular video frame from said sequence of video frames; and
storing at least part of said particular video frame as said image in said store.

2. Method as claimed in claim 1, further comprising the step of:
enabling selection of an entry from among said plurality of entries on the basis of said image of said one of said persons.

3. Method as claimed in claim 2, the enabling step comprising the steps of:
presenting said image of said one of said persons on a display along with a plurality of further images of further persons of said plurality of persons;
providing an indicium on the display, the indicium indicating which one of the entries is ready for selection in response to an input signal; and
moving the indicium on the display in response to a further input signal.

4. Method as claimed in claim 2, wherein said plurality of persons are subscribers to said communication network and wherein the store has a function as directory of said subscribers to said communication network.

5. Method as claimed in claim 4 wherein said selection invokes establishing a communication connection with said one of said persons.

6. Communication apparatus (100; 200) comprising:
connection means (240) for establishing a video connection and for during the video connection receiving a sequence of video frames; and
a display (120; 230) for displaying the video frames,
directory control means (210) for controlling a directory having a plurality of entries of a plurality of corresponding persons;
characterized in that the directory control means (210) are arranged for selecting a particular video frame from said sequence of video frames and for storing at least part of said particular video frame in said directory.

7. Communication apparatus (100; 200) as claimed in claim 6, the directory control means (210) further being arranged for presenting the directory including said at least part of said particular video frame on said display (230) and for activating the connection means (240) in response to selection of said at least part of said particular video frame.
